(19) United States
(12) Patent Application Publication
(10) Pub. No.: US 2012/0115979 A1
(43) Pub. Date: May 10, 2012

(54) CHLORINATED POLYMER ENHANCING WETTABILITY OF SILICONE HYDROGEL, SILICONE HYDROGEL COMPRISING THE SAME AND OCULAR ARTICLE MADE THEREFROM

(76) Inventors: KEN-YUAN CHANG, TAIPEI CITY (TW); CHIH-TA LEE, TAIPEI CITY (TW); CHIA-CHANG LIU, TAIPEI CITY (TW); CHUN-YI LI, TAIPEI CITY (TW)

(21) Appl. No.: 13/177,925

(22) Filed: Jul. 7, 2011

(30) Foreign Application Priority Data
Nov. 10, 2010 (TW) 099138737

(51) Int. Cl. C08L 83/00; C08F 26/10

(52) U.S. Cl. 523/107; 526/264

(57) ABSTRACT

The present invention provides a reactive hydrophilic polymer comprising units of Formulae (I) and (II):

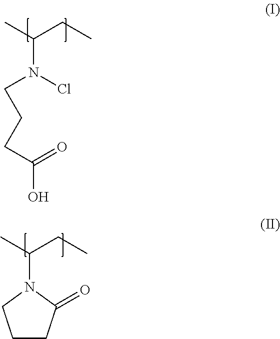

wherein the ratio of the mole number of the unit of Formula (I) to the total mole number of the units of Formulae (I) and (II) is from 0.002 to 0.04, and the reactive hydrophilic polymer has a molecular weight from 10,000 to 2,000,000. The present invention also provides a silicone hydrogel comprising the reactive hydrophilic polymer and ocular articles made therefrom.

### BACKGROUND OF THE INVENTION

1. Field of the Invention

The present invention relates to a reactive hydrophilic polymer, which can be added into a formulation of silicone hydrogel for forming an ocular article, so as to improve the surface wettability of the ocular article. The present invention further relates to a modified ocular article made from the silicone hydrogel, and especially a contact lens or an intraocular lens (IOL).

2. Description of the Prior Art

So far, the contact lens has a development history of almost one hundred years, and is one of the important medical devices generally used by common lens population. In 1950s, a Czechoslovak scientist prepared a hydrogel by using poly(hydroxyethyl methacrylate (HEMA), and invented a flexible contact lens, and this material is still used now. With the advancement of science and technology, the material of the contact lens also evolves towards high oxygen permeability and high comfort.

Generally, the properties of the contact lens such as safety, light transmittance, oxygen permeability, and wear comfort need to be emphasized. The traditional HEMA hydrogel, due to the hydrophilicity, has good wear comfort, but low oxygen permeability, and thus long-term wearing likely causes corneal edema and angiogenesis. In order to improve the oxygen permeability of the HEMA hydrogel, a generally used strategy is to reduce the lens thickness and improve the water content of the lens, but which bring limited improvement of the performance, and are frequently accompanied with the disadvantage of loss of mechanical properties of the lens. In recent years, many studies are focused on development of contact lens containing a silicone material, which enable oxygen to successfully penetrate the lens and reach the cornea by means of the high oxygen permeability of the silicon material, thereby both the oxygen permeability of the contact lens and the wear comfort are improved. At present, the most common used silicone material is poly(dimethylsiloxane): as the silicone material is more hydrophobic and has a poor wettability, the eyes trend to be dry and discomfort in the wearing, which is also a direction towards which the silicone hydrogel contact lens needs to be actively improved at present.

Generally, methods for improving the wettability of the silicone hydrogel can be substantially classified into two types.

(1) Hydrophilic post-processing treatment on the formed lens: the methods include treating the surface of the silicone hydrogel with plasma, as disclosed in U.S. Pat. No. 4,214,014, and coating a silane coupling agent onto the surface of the formed silicone hydrogel lens and immersing the lens into a hydrophilic substance, to graft the hydrophilic substance onto the surface of the lens by means of a chemical bond, so as to improve the surface wettability of the lens, as disclosed in U.S. Pat. No. 6,099,852. Although the post-processing methods can improve the wettability, they are scarcely used in practical production due to the high fabrication cost caused by the troublesome processing process and the lack of efficiency in the preparation process.

(2) Addition of hydrophilic molecules in the formulation of silicone hydrogel: the methods can improve the surface wettability of the lens without influencing the original preparation process, and thus become a main stream for improving the wettability of the contact lens.

Poly-N-vinylpyrrolidone (PVP) is a hydrophilic polymer material. U.S. Pat. No. 6,367,929 discloses addition of a hydrophilic polymer (for example. PVP) of high molecular weight in the main ingredients of silicone hydrogel. In the procedure of forming the lens, intra-molecule physical entanglement occurs among the PVP molecules and other cross-linked molecules in a network extension manner, such that the surface of the silicone hydrogel lens has the wettability effect. However, because no chemical bonds exist between the PVP molecules and the lens, the PVP molecules in the lens will gradually leach out over time, so that the lens loses the wettability, and a quite dry and uncomfortable sense is felt

In addition, in order to avoid the influence caused by the insufficient compatibility of the composition of the hydrophilic compound and silicone hydrogel on the optical properties of the lens, an additional compatilizer needs to be added to the silicone hydrogel composition. U.S. Pat. No. 7,052,131 discloses that a compatilizer is additionally introduced, when a high molecular weight PVP is used, so that PVP and the silicone hydrogel are compatible with each other in the presence of the compatilizer. However, in addition to the increased complexity of the formulation, the properties of molecules of the original formation must be considered in the design and selection of the additionally added compatilizer.

In view of this, relevant disclosure exists in the prior art, in which reactive hydrophilic molecules having reactivity and capable of being co-polymerized with main ingredients of the formulation are added into the main ingredients of the silicone hydrogel. For example, U.S. Pat. Nos. 5,219,965, 5.364.918 and 5,525,691 disclose that an vinyl-based functional group is introduced into the PVP molecular chain, which may be chemically bonded to the substance having a vinyl group in the silicone hydrogel formulation, so that the hydrophilic chain is grafted into the whole silicone hydrogel formulation through a covalent bond, thereby the lens is imparted with a long-term wettability in the preparation process of the lens. However, in the polymerization reaction procedure, when the vinyl-based functional group is polymerized, the high molecular weight PVP is not easily to react with other monomers in the formulation due to the steric hindrance, and thus the method of grafting the vinyl group onto PVP is only suitable for the modification of low molecular weight (of about 500 to 10,000) PVP. In practical application in forming the lens, because the length of the hydrophilic chain of the low molecular weight PVP molecule is inadequate, the effect for improving the surface wettability of the lens is limited. Therefore, although low molecular weight PVP can be easily modified with the vinyl group, the addition of the modified low molecular weight PVP into the formulation cannot easily achieve the wettability effect.

To sum up, there is still a need for a technical solution in the industry, which can directly modify the high molecular weight reactive hydrophilic molecule to have a reactive chain, so as to improve the surface wettability of the silicone hydrogel material.

### SUMMARY OF THE INVENTION

The present invention is directed to a reactive hydrophilic polymer for enhancing the surface wettability of an ocular article. The reactive hydrophilic polymer comprises units of Formulae (I) and (ID:

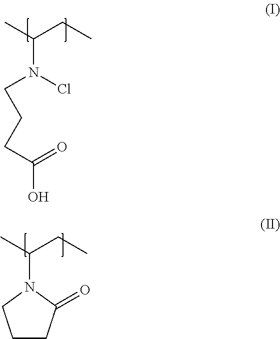

wherein the ratio of the mole number of the unit of Formula (I) to the total mole number of the units of Formulae (I) and (II) is from 0.002 to 0.04, and the reactive hydrophilic polymer has a molecular weight from 10,000 to 2,000,000.

The present invention is further directed to a silicone hydrogel comprising a reaction product of the following components:

(a) a monomer mixture of the silicone hydrogel as a main ingredient of the silicone hydrogel, which comprises at least one silicon-containing monomer containing a carbon-carbon double bond; and

(b) the reactive hydrophilic polymer of the present invention.

The present invention is further directed to an ocular article made from the silicone hydrogel of the present invention.

Compared with the prior art, the modified reactive hydrophilic polymer of the present invention can generate a disassociated reactive free radical, which is reacted with a monomer having an unsaturated vinyl group, especially when being added into the silicone hydrogel, the dissociable free radical of the modified hydrophilic polymer is reacted with the reactive monomer contained in the silicone hydrogel, so that not only the overall wettability of the silicone hydrogel is improved, but also the hydrophilic polymer is prevented from being dissociated and released from the silicone hydrogel composition, thereby effectively solving the problem existing in the prior art.

### BRIEF DESCRIPTION OF THE DRAWINGS

FIG. 1 is an IR spectrum of an HEMA hydrogel added with a reactive hydrophilic polymer of the present invention.

FIG. 2 is an IR spectrum of an HEMA hydrogel without adding any hydrophilic polymer.

FIG. 3 is an IR spectrum of an HEMA hydrogel added with un-reactive PVP.

FIG. 4 shows surface contact angle data of silicone hydrogel films of Examples 8 to 10 and Comparative Examples 4 and 5.

### DETAILED DESCRIPTION OF THE INVENTION

In order to make the features and advantages of the present invention more comprehensible, the present invention is described in further detail below with reference to preferred embodiments and the accompanying drawings.

The reactive hydrophilic polymer for enhancing the surface wettability of an ocular article of the present invention comprises units of Formulae (I) and (II):

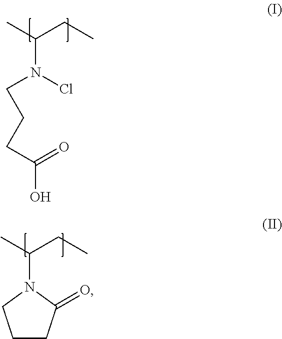

and may be prepared as follows.

Sodium hypochlorite (NaOCl) is used to open the ring of PVR to obtain a chain having an N-H group and a COOH group (Wienk et al., J. polym. sci., A, Polym. chem. 33:49 (1995)), and the reaction mechanism is as shown in Reaction Formula 1:

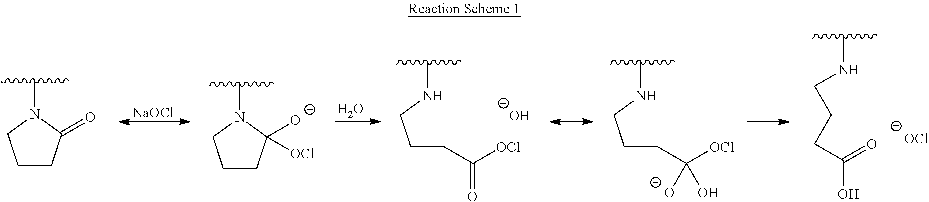

(2) The N-H group may be further reacted with sodium hypochlorite, to obtain an N—Cl group, and thus PVP is chlorinated (Fair et al., J. AM. Water Works Assoc., 40:1051 (1948)), and the reaction mechanism is as shown in Reaction Formula 2:

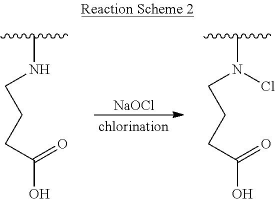

In the reactive hydrophilic polymer of the present invention, the N—Cl group is decomposed with heat or irradiation with light to form a free radical, which may be bonded to a carbon-carbon double bond or initialize the polymerization reaction of the carbon-carbon double bond. Therefore, chlorinated PVP added into the silicone hydrogel formulation may be co-polymerized with a monomer having a carbon-carbon double bond in the formulation, thereby forming a stable covalent bond, and avoiding the leaching out of the hydrophilic polymer from the silicone hydrogel. In addition, compared with a pentacyclic lactam, chlorinated PVP has a more hydrophilic COOH chain, and thus, the hydrophilic polymer of the present invention not only can be reacted with the silicone hydrogel, but also can improve the hydrophilicity and wettability of the silicone hydrogel. A reactive hydrophilic polymer useful in the present invention has a molecular weight from 10,000 to 2,000,000, preferably from 30,000 to 1,500,000, and more preferably from 50,000 to 1,300,000. In the reactive hydrophilic polymer, the ratio of the mole number of the unit of Formula (I) to the total mole number of the units of Formulae (I) and (II) is from 0.002 to 0.04, preferably from 0.003 to 0.03, and more preferably from 0.005 to 0.02.

The present invention further provides a silicone hydrogel comprising a reaction product of the following ingredients:

(a) a monomer mixture of the silicone hydrogel as a main ingredient of the silicone hydrogel, which comprises at least one silicon-containing monomer containing a carbon-carbon double bond; and

(b) the reactive hydrophilic polymer according to the present invention, wherein the reactive hydrophilic polymer is used in an amount of 1 to 10 wt %, preferably 2 to 8 wt %, and more preferably 3 to 5 wt %, based on the total weight of the silicone hydrogel.

The silicone hydrogel is generally prepared by polymerizing a monomer mixture mainly including at least one silicon-containing monomer containing a carbon-carbon double bond. “Silicone” as mentioned herein means a material which is an organic polymer containing at least 5 wt %, preferably 10 to 100 wt %, and more preferably 30 to 90 wt % of a silicon-oxygen chain (—OSi— chain).

Term “monomer” as used herein contemplates a polymerizable low molecular weight compound (generally having a number average molecular weight less than 700), and a polymerizable medium to high molecular weight compound or polymer which is sometimes referred to as macromonomer (generally having a number average molecular weight greater than 700). Therefore, it should be understood that phases “silicon-containing monomer” and “hydrophilic monomer” as used herein include a monomer, a macromonomer, and a pre-polymer. The prepolymer is a partially polymerized monomer or a monomer which can be further polymerized.

The reactive hydrophilic polymer of the present invention can be bonded to the silicon-containing monomer containing a carbon-carbon double bond in the Silicone hydrogel, thereby improving the surface wettability and prolonging the effect.

The silicon-containing monomer containing a carbon-Carbon double bond useful in the present invention has a group including, but not limited to, vinyl, propenyl, acryloyl, and methacryloyl. Suitable silicon-containing monomers include, but are not limited to, (trimethylsiloxy)-3-methacryloxypropylsilane, 3-(triethoxysilyl)propyl methacrylate), 3-diethoxymethylsilyl)-propyl methacrylate, vinyltrimethoxysilane, vinyltriethoxysilane, diethoxy(methyl)vinylsilane, 3-methacryloxypropyl-methyldimethoxysilane, 3-methacryloxypropyl-methyldiethoxysilane, 3-methacryloxypropyl-trimethoxysilane, 3-methacryloxypropyl-triethoxysilane, vinyltri(isopropoxy)silane, vinyltripropoxysilane, tris(trimethylsiloxy)silylpropyl methacrylate, bis(trimethylsiloxy)methylsilylpropyl methacrylate, pentamethyldisiloxanepropyl methacrylate, tris(trimethylsiloxy)silyl propyloxyethyl methacrylate, or tris(polydimethylsiloxy)silylpropyl methacrylate or a mixture thereof.

As the conventional silicon-containing monomer containing a carbon-carbon double bond is a hydrophobic material, an ocular article made from the silicone hydrogel based on the monomer generally also has a high hydrophobicity. Although this property does not affect the optical properties of the ocular article, discomfort is caused in wearing due to the high hydrophobicity. In order to improve the wearing comfort, a hydrophilic monomer containing a carbon-carbon double bond is conventionally further added into the monomer mixture as desired, so as to improve the hydrophilicity of the ocular article, thereby improving the wearing comfort.

In the present invention, the hydrophilicity of the silicone hydrogel may also be improved by adding a hydrophilic monomer containing a carbon-carbon double bond; however, if the hydrophilic monomer containing a carbon-carbon double bond is added in an excessive amount, the properties of the silicone hydrogel will be changed (for example, oxygen permeability is lowered). As a result, when the monomer mixture further contains a hydrophilic monomer containing a carbon-carbon double bond, the amount of the hydrophilic monomer containing a carbon-carbon double bond is preferably 30 to 68 wt %, more preferably 35 to 63 wt %, and most preferably 40 to 58 wt %, based on the total weight of the silicone hydrogel. In contrast, the amount of the silicon-containing monomer containing a carbon-carbon double bond is preferably 30 to 68 wt %, more preferably 35 to 63 wt %, and most preferably 40 to 58 wt %, based on the total weight of the silicone hydrogel.

The hydrophilic monomer containing a carbon-carbon double bond useful in the present invention has a group including, but not limited to, vinyl, propenyl, acryloyl, and methacryloyl. Suitable hydrophilic monomers include, but are not limited to methacrylic acid, acrylic acid, vinyl acetate, ethylene glycol dimethylacrylate (EGDMA), 2-hydroxyethyl methacrylate, 2-hydroxyethyl acrylate, glycerol methacrylate, 2-dimethylaminoethyl acrylate, N-vinyl-N-methyl acetamide, N-vinyl-formamide, N-vinyl pyrrolidone, acryloylmorpholine, methacrylamide, N,N-dimethylacrylamide, N,N-diethylacrylamide, 2-hydroxyethyl methacrylamide, or N-isopropylacrylamide or a mixture thereof.

As the hydrophilic monomer containing a carbon-carbon double bond also has a carbon-carbon double bond, the reactive hydrophilic polymer of the present invention may also be bonded to the hydrophilic monomer containing a carbon-carbon double bond in the silicone hydrogel, thereby improving and prolonging the surface wettability of the lens.

In co-polymerization, the silicone hydrogel of the present invention may be cured by, for example. UV polymerization, polymerization with free radical and thermal initiator and heat, or a combination thereof, so as to be cast and formed. Representative free radical and thermal polymerization initiators includes organic peroxides, for example, acetyl peroxide, lauroyl peroxide, decanoyl peroxide, stearoyl peroxide, benzoyl peroxide, t-butyl pivalate peroxide, dicarbonate peroxide, and a commercial thermal initiator such as LUPERSOL® 256,225 (Atofina Chemical, Philadelphia, Pa.), and the like. The initiator is used at a concentration of about 0.01 to 2 wt % in the monomer mixture. The representative UV initiators are those known in the art, for example, but not limited to, diphenyl ethanedione methyl ether, diphenyl ethanedione ethyl ether, DAROCUR® 1173, 1164, 2273, 1116, 2959, 3331, IGRACURE® 651 and 184 (Ciba Specialty Chemicals, Ardsley, N.Y.).

As known by persons of ordinary skill in the art, in addition to the polymerization initiator, the silicone hydrogel of the present invention also optionally includes other components, for example, an additional colorant, a UV absorbent, and an additional processing auxiliary, such as those known in the technology of contact lens.

The silicone hydrogel generated by adding the reactive hydrophilic polymer of the present invention has properties of good oxygen permeability, excellent surface wettability, and long-term wettability, and thus are very suitable as an ocular article, especially a contact lens or an intraocular lens (IOL).

A contact lens may be formed from the silicone hydrogel of the present invention through a spin casting process disclosed in, for example, U.S. Pat. Nos. 3,408,429 and 3,496,254, a cast molding process disclosed in, for example, U.S. Pat. Nos. 5,271,875, and other conventional compression molding processes disclosed in, for example, U.S. Pat. No. 4,084,459. The polymerization of the monomer mixture may be conducted in a spin casting or a fixed molding corresponding to the shape of the contact lens. If necessary, the contact lens thus obtained may be further mechanically polished. The polymerization may also be conducted in a suitable mold or container to obtain the lens material having a button shape, a disc shape, or a rod shape, which may be further processed (for example, by machining, laser cutting, lathing or polishing), to obtain a contact lens having a desired shape.

The present invention is further described below through the following embodiments; however the present invention is not limited thereto. Any equivalent replacement of modification or improvement made by one skilled in the art without departing from the spirit and scope of the present invention is also intended to be included within the scope of the following claims.

### EXAMPLES

### Synthetic Chemicals

1. Polyvinyl pyrrolidone (PVP): available from Sigma, product codes K90 (molecular weight: 1,300,000), K30 (molecular weight: 50.000), and K12 (molecular weight: 4,000).

2. Sodium hypochlorite (NaOCl): 6-14%, available from Riedel-de Haën.

3. N-vinyl pyrrolidone (NVP):

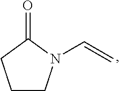

available from Sigma.

4. CoatOsil:

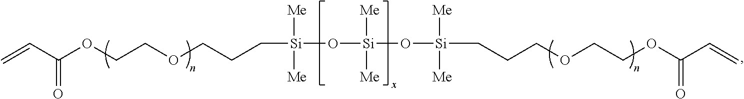

available from GE silicones.

5. (Trimethylsilyloxy)-3-methylpropenyloxypropylsilane (TRIS):

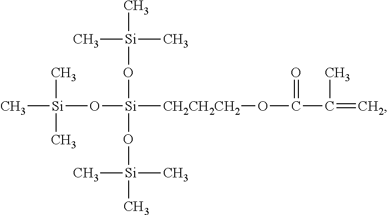

available from Sigma.

6. 2-Hydroxyethyl methacrylate (HEMA):

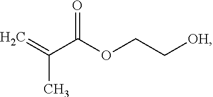

available from Sigma.

7. Methacrylic acid (MA):

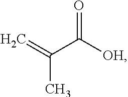

available from Sigma.

8. D1173 photo initiator: available from Ciba Chemicals.

9. Ethylene glycol dimethyl acrylate (EGDMA):

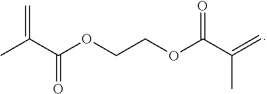

available from Sigma.

### Preparation of Reactive Hydrophilic Polymer

### Example 1

10.0 g PVP (molecular weight 1,300,000) was placed in a single-neck 250 mL flask, and 140 mL water was added. 0.4375 g of 7.66 wt % aqueous sodium hypochlorite (NaOCl) solution was added, and then the reaction solution was adjusted with diluted hydrochloric acid to pH 4, and reacted for 8 hrs at room temperature. Water and remaining sodium hypochlorite was removed through evaporation under vacuum, and chlorinated PVP (PVP—Cl) as a white solid was collected. Remaining salts in solid PVP—Cl were removed through dialysis (dialysis membrane with MW of about 6 to 8K), and then element contents was identified with an energy dispersive spectrometer (EDS), in which the molar ratio of the units of Formulae (I) and (II) were as shown in Table 1.

### Example 2

The feed ratio and reaction conditions were the same as those in Example 1, except that the amount of sodium hypochlorite added was changed to be 0.875 g, and a white solid (PVP—Cl) was obtained. Remaining salts in solid PVP—Cl were removed through dialysis (dialysis membrane with MW of about 6 to 8K), and then element contents was identified with an EDS, in which the molar ratio of the units of Formulae (I) and (II) were as shown in Table 1.

### Example 3

The feed ratio and reaction conditions were the same as those in Example 1, except that the amount of sodium hypochlorite was changed to be 1.750 g, and a white solid (PVP—Cl) was obtained. Remaining salts in solid PVP—Cl were removed through dialysis (dialysis membrane with MW of about 6 to 8K), and then element contents was identified with an EDS, in which the molar ratio of the units of Formulae (I) and (II) were as shown in Table 1.

### Example 4

The feed ratio and reaction conditions were the same as those in Example 1, except that the amount of sodium hypochlorite was changed to be 4.375 g, and a white solid (PVP—Cl) was obtained. Remaining salts in solid PVP—Cl were removed through dialysis (dialysis membrane with MW of about 6 to 8K), and then element contents was identified with an EDS, in which the molar ratio of the units of Formulae (I) and (II) were as shown in Table 1.

### Example 5

The feed ratio and reaction conditions were the same as those in Example 3, except that the molecular weight of PVP was changed to be 50,000, and a white solid (PVP—Cl) was obtained. Remaining salts in solid PVP—Cl were removed through dialysis (dialysis membrane with MW of about 6 to 8K), and then element contents was identified with an EDS, in which the molar ratio of the units of Formulae (I) and (II) were as shown in Table 1.

### Example 6

The feed ratio and reaction conditions were the same as those in Example 3, except that the molecular weight of PVP was changed to be 4,000, and a white solid (PVP—Cl) was obtained. Remaining salts in solid PVP—Cl were removed through dialysis (dialysis membrane with MW of about 6 to 8K), and then element contents was identified with an EDS, in which the molar ratio of the units of Formulae (I) and (II) were as shown in Table 1.

### Comparative Example 1

Element contents of unmodified PVP (molecular weight 1,300,000) were identified, in which the molar ratio of the units of Formulae (I) and (II) were as shown in Table 1.

TABLE 1

| | Molecular | Ratio of mole number of the unit of |
|---|---|---|
| | weight of | Formula (I) to the total mole number |
| Embodiment | PVP | of the units of Formulae (I) and (II) |
| Example 1 | 1,300,000 | 0.005 |
| Example 2 | 1,300,000 | 0.01 |
| Example 3 | 1,300.000 | 0.02 |
| Example 4 | 1,300,000 | 0.05 |
| Example 5 | 50,000 | 0.02 |
| Example 6 | 4,000 | 0.02 |
| Comparative | 1,300,000 | 0 |
| Example 1 | | |

### Chemical Bond Test of Reactive Hydrophilic Polymer

### Example 7

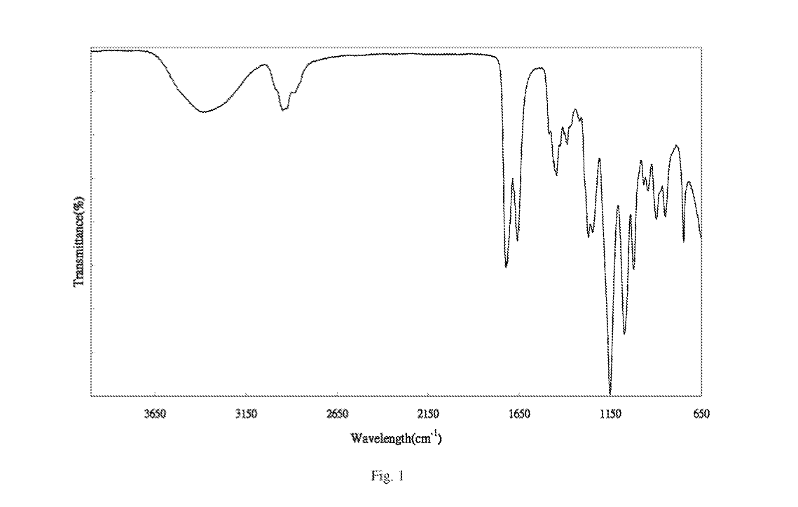

98% of HEMA monomer was placed in a reaction flask, then 1% of EGDMA crosslinker, 1% of D1173 initiator, and 5% of the reactive hydrophilic polymer obtained in Example 2 were added and uniformly mixed, and then the cross-linking reaction was conducted with UV. The resulting reaction product was placed in 10 times ethanol, and extracted for 24 hrs at 50° C. Then, the product was placed in ten times saline which was refreshed every 6 to 8 hrs for secondary extraction over about three days, to ensure that all the unreacted monomers were washed out. Finally, the product extracted with ethanol and saline was dried at 80° C. and identified with IR spectroscopy. The result was as shown in FIG. 1.

### Comparative Example 2

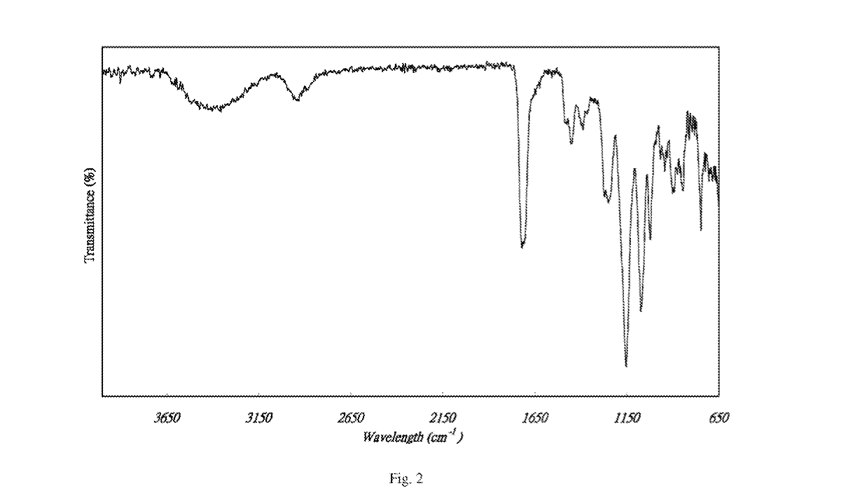

98% of HEMA monomer was placed in a reaction flask, then 1% of EGDMA crosslinker, and 1% of D1173 initiator were added and uniformly mixed, and then the cross-linking reaction was conducted with UV. The steps and conditions were the same as those in Example 7, and the resulting reaction product was extracted with ethanol followed by saline, dried, and identified with IR spectroscopy. The result was as shown in FIG. 2.

### Comparative Example 3

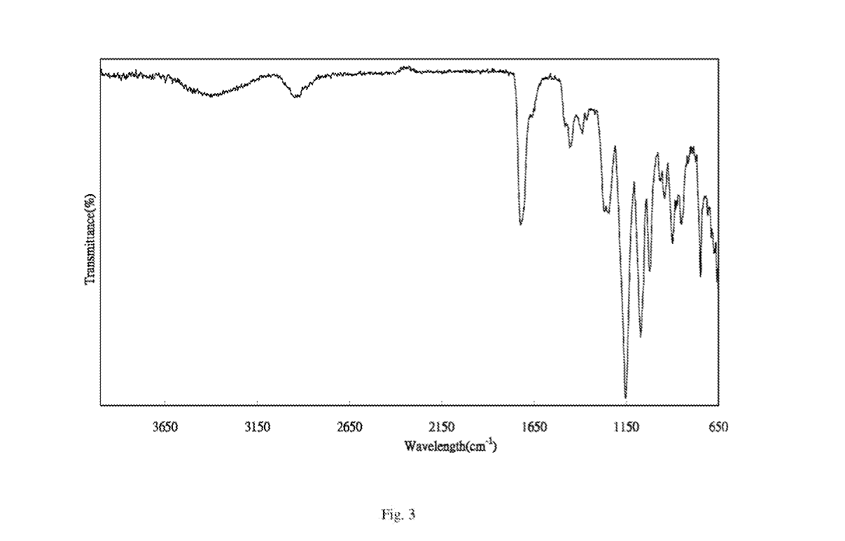

98% of HEMA monomer was placed in a reaction flask, then 1% of EGDMA crosslinker, 1% of D1173 initiator, and 5% of PVP (molecular weight: 1,300,000) were added and uniformly mixed, and then the cross-linking reaction was conducted with UV. The steps and conditions were the same as those in Example 7, and the resulting reaction product was extracted with ethanol followed by saline, dried, and identified with IR spectroscopy. The result was as shown in FIG. 3.

In the IR spectra, the characteristic absorption peak of the PVP structure appears at wave number 1663 cm⁻¹. Because PVP is not added in Comparative Example 2, there is obviously no specific absorption peak of PVP in FIG. 2; there is also no obvious specific absorption peak of PVP in FIG. 3, so it is indicated that hydrophilic PVP is washed out through long-time extraction if PVP having no reactivity is added alone; However, the existence of the specific absorption can be observed in FIG. 1, suggesting that modified PVP has reactivity, can be reacted with the monomer having a carbon-carbon double bond, thus definitely grafted in the material, and cannot be washed out after long-time extraction.

### Preparation of Silicone Hydrogel

### Examples 8 to 0.13 and Comparative Examples 4 and 5

According to the composition and contents shown in Table 2, the reactive hydrophilic polymer was added to the monomer mixture for forming the silicone hydrogel, and cross-linked through UV irradiation, to prepare the silicone hydrogel films of Examples 8 to 13 and Comparative Examples 4 and 5.

TABLE 2

| | | | | | | | | Comparative | |
|---|---|---|---|---|---|---|---|---|---|
| | | Example | | | | | | Example | |
| Ingredient | | 8 | 9 | 10 | 11 | 12 | 13 | 4 | 5 |
| HEMA (g) | | 0.94 | 0.94 | 0.94 | 0.94 | 0.94 | 0.94 | 0.94 | 0.94 |
| NVP (g) | | 2.44 | 2.44 | 2.44 | 2.44 | 2.44 | 2.44 | 2.44 | 2.44 |
| MA (g) | | 0.11 | 0.11 | 0.11 | 0.11 | 0.11 | 0.11 | 0.11 | 0.11 |
| TRIS (g) | | 2.53 | 2.53 | 2.53 | 2.53 | 2.53 | 2.53 | 2.53 | 2.53 |
| CoatOsil (g) | | 1.13 | 1.13 | 1.13 | 1.13 | 1.13 | 1.13 | 1.13 | 1.13 |
| EGDMA (g) | | 0.01 | 0.01 | 0.01 | 0.01 | 0.01 | 0.01 | 0.01 | 0.01 |
| Hexanol (g) | | 2.00 | 2.00 | 2.00 | 2.00 | 2.00 | 2.00 | 2.00 | 2.00 |
| Hydrophilic | Example 1 | 0.36 | 0 | 0 | 0 | 0 | 0 | 0 | 0 |
| polymer (g) | Example 2 | 0 | 0.36 | 0 | 0 | 0 | 0 | 0 | 0 |
| | Example 3 | 0 | 0 | 0.36 | 0 | 0.07 | 0.22 | 0 | 0 |
| | Example 4 | 0 | 0 | 0 | 0.36 | 0 | 0 | 0 | 0 |
| | Comparative | 0 | 0 | 0 | 0 | 0 | 0 | 0.36 | 0 |
| | Example 1 | | | | | | | | |

| | | | | | | | | |
|---|---|---|---|---|---|---|---|---|
| D1173 (mg) | 53.48 | 53.48 | 53.48 | 53.48 | 53.48 | 53.48 | 53.48 | 53.48 |

### Moisture Content Test

The silicone hydrogel films formed by cross-linking through UV irradiation of Examples 8 to 12 and Comparative Examples 4 and 5 were immersed in water, balanced, taken out from water, wiped off the water on the surface, and weighed to obtain a wet weight of W₀. At the room temperature of 25° C., the film was stood and weighed at 5 min and 10 min, to obtain weights W₁ and W₂ respectively. Then, the film was placed in an oven, dried for 24 hrs at 110° C. to remove water in the material, and weighed to obtain a dry weight W₃. The water loss rate and water content were calculated through equations below, and the results were shown in Table 3.

$$Water loss rate ( at 5 min ) \% = \frac{{W}_{0} - {W}_{1}}{{W}_{0}} \times 100 \% , \\ Water loss rate ( at 10 min ) \% = \frac{{W}_{0} - {W}_{2}}{{W}_{0}} \times 100 \% , \\ Water content ( overall ) \% = \frac{{W}_{0} - {W}_{3}}{{W}_{0}} \times 100 \% .$$

### Evaluation of Wettability Effect

The silicone hydrogel films formed by cross-linking through UV irradiation of Examples 8 to 12 and Comparative Examples 4 and 5 were immersed in water, balanced, taken out from water, and observed. If the aqueous film on the surface of the film can resist aggregation for over 30 s, the wettability effect is defined as “Good”; if the aqueous film on the surface of the film can resist aggregation for 5 to 30 s, the wettability effect is defined as “Mild”; and if the aqueous layer on the surface of the film is aggregated into a water drop in 5 s, and no wettability effect was observed, the wettability effect is defined as “Bad”. The results are shown in Table 3.

TABLE 3

| | | Water loss | | Water |
|---|---|---|---|---|
| | Wettability | rate % | | content % |
| | effect | 5 min | 10 min | (overall) |
| Example 8 | Good | 19.70 | 36.89 | 42.03 |
| Example 9 | Good | 20.97 | 36.76 | 42.34 |
| Example 10 | Good | 20.40 | 38.22 | 42.62 |
| Example 11 | Bad | 24.39 | 40.11 | 42.35 |
| Example 12 | Mild | 23.02 | 38.79 | 42.12 |
| Example 13 | Good | 20.67 | 38.42 | 42.27 |
| Comparative Example 4 | Good | 20.37 | 40.72 | 42.33 |
| Comparative Example 5 | Bad | 26.13 | 48.66 | 35.23 |

### Contact Angle Test

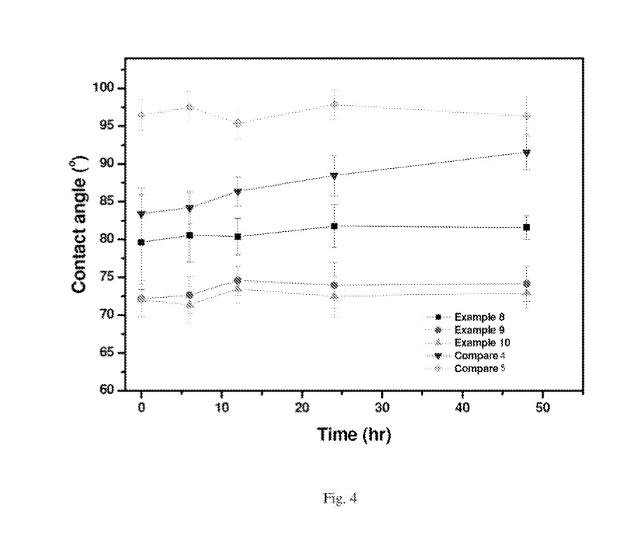

The surface contact angles of the silicone hydrogel films of Examples 8 to 12 and Comparative Examples 4 and 5 varying over time were measured with a contact angle meter. When the liquid was dropped on a surface of a solid, an angle between the surface of the solid and a tangent of the droplet is the “contact angle”. When the contact angle is 0 degree, it is indicated that the liquid can fully wet the solid surface; and when the contact angle is 180 degrees, it is indicated that the liquid cannot wet the solid surface at all. The data of contact angle test is as shown in Table 4 and FIG. 4 below.

TABLE 4

| | (Degree) | | | | |
|---|---|---|---|---|---|
| | Example | | | Comparative Example | |
| hr | 8 | 9 | 10 | 4 | 5 |
| 0 | 79.65 ± 6.28 | 72.18 ± 2.36 | 72.05 ± 2.01 | 83.42 ± 3.38 | 96.45 ± 1.99 |
| 6 | 80.57 ± 3.54 | 72.65 ± 2.54 | 71.36 ± 2.45 | 84.21 ± 2.15 | 97.52 ± 2.03 |
| 12 | 80.39 ± 2.45 | 74.59 ± 1.95 | 73.48 ± 1.85 | 86.37 ± 1.88 | 95.38 ± 2.11 |
| 24 | 81.78 ± 2.86 | 73.95 ± 3.01 | 72.48 ± 2.68 | 88.48 ± 2.67 | 97.85 ± 1.91 |
| 48 | 81.59 ± 1.57 | 74.15 ± 2.35 | 72.96 ± 2.14 | 91.56 ± 2.34 | 96.33 ± 2.63 |

It can be known from the contact angle data in Table 4 and FIG. 4 that, the films of Examples 8 to 10 have a surface contact angle that is lower than that of the films of Comparative Examples 4 and 5. and thus have a good wettability effect, and the reactive hydrophilic polymer of the present invention can be effectively bonded on the silicone hydrogel, such that the surface of the silicone hydrogel film of Examples 8 to 10 was maintained to have a long time wettability effect. In the silicone hydrogel film of Comparative Example 4, a hydrophilic polymer without reactive functional groups is added, and the polymer molecule chain exists in the silicone hydrogel in the manner of entanglement, and is gradually lost over time, such that the silicone hydrogel gradually loses the wettability effect. Therefore, the contact angle of Comparative Example 4 increases with time.

It should be understood that various modifications of the present invention are feasible, and are easily occurred to and contemplated by those skilled in the art.

1. A reactive hydrophilic polymer for enhancing the surface wettability of an ocular article comprising units of Formulae (I) and (II): 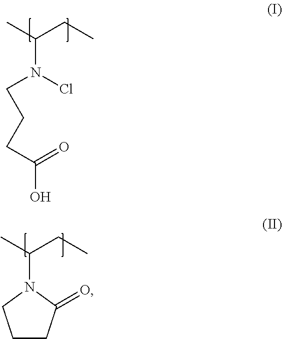
wherein the ratio of the mole number of the unit of Formula (I) to the total mole number of the units of Formulae (I) and (II) is from 0.002 to 0.04, and the reactive hydrophilic polymer has a molecular weight from 10,000 to 2,000,000.

2. The reactive hydrophilic polymer according to claim 1, wherein the ratio of the mole number of the unit of Formula (I) to the total mole number of the units of Formulae (I) and (II) is from 0.003 to 0.03.

3. The reactive hydrophilic polymer according to claim 2, wherein the ratio of the mole number of the unit of Formula (I) to the total mole number of the units of Formulae (I) and (II) is from 0.005 to 0.02.

4. The reactive hydrophilic polymer according to claim 1, wherein the reactive hydrophilic polymer has a molecular weight from 30,000 to 1,500,000.

5. The reactive hydrophilic polymer according to claim 4, wherein the reactive hydrophilic polymer has a molecular weight from 50,000 to 1,300,000.

6. The reactive hydrophilic polymer according to claim 1, wherein the ocular article is a contact lens or an intraocular lens.

7. A silicone hydrogel for an ocular article comprising a reaction product of the following ingredients:
(a) a monomer mixture for the silicone hydrogel, which comprises at least one silicon-containing monomer containing a carbon-carbon double bond; and
(b) a reactive hydrophilic polymer comprising units of Formulae (I) and (II): 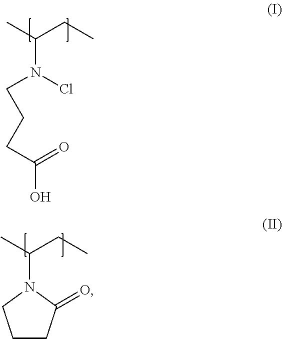
wherein the ratio of the mole number of the unit of Formula (I) to the total mole number of the units of Formulae (I) and (II) is from 0.002 to 0.04, and the reactive hydrophilic polymer has a molecular weight from 10,000 to 2.000,000.

8. The silicone hydrogel according to claim 7, wherein the reactive hydrophilic polymer is used in an amount of 1 to 10 wt % based on the total weight of the silicone hydrogel.

9. The silicone hydrogel according to claim 8, wherein the reactive hydrophilic polymer is used in an amount of 2 to 8 wt % based on the total weight of the silicone hydrogel.

10. The silicone hydrogel according to claim 9, wherein the reactive hydrophilic polymer is used in an amount of 3 to 5 wt % based on the total weight of the silicone hydrogel.

11. The silicone hydrogel according to claim 7, wherein the monomer mixture for the silicone hydrogel further comprises a hydrophilic monomer having a carbon-carbon double bond.

12. The silicone hydrogel according to claim 11, wherein the hydrophilic monomer having a carbon-carbon double bond is used in an amount of 30 to 68 wt % based on the total weight of the silicone hydrogel.

13. The silicone hydrogel according to claim 12, wherein the hydrophilic monomer having a carbon-carbon double bond is used in an amount of 35 to 63 wt % based on the total weight of the silicone hydrogel.

14. The silicone hydrogel according to claim 13, wherein the hydrophilic monomer having a carbon-carbon double bond is used in an amount of 40 to 58 wt % based on the total weight of the silicone hydrogel.

15. The silicone hydrogel according to claim 11, wherein the silicon-containing monomer containing a carbon-carbon double bond is used in an amount of 30 to 68 wt % based on the total weight of the silicone hydrogel.

16. The silicone hydrogel according to claim 15, wherein the silicon-containing monomer containing a carbon-carbon double bond is used in an amount of 35 to 63 wt % based on the total weight of the silicone hydrogel.

17. The silicone hydrogel according to claim 16, wherein the silicon-containing monomer containing a carbon-carbon double bond is used in an amount of 40 to 58 wt % based on the total weight of the silicone hydrogel.

18. The silicone hydrogel according to claim 7, wherein the silicon-containing monomer containing a carbon-carbon double bond has a group selected from the group consisting of vinyl, propenyl, acryloyl, and methacryloyl.

19. The silicone hydrogel according to claim 11, wherein the hydrophilic monomer having a carbon-carbon double bond has a group selected from the group consisting of vinyl, propenyl, acryloyl, and methacryloyl.

20. The silicone hydrogel according to claim 7, wherein the silicon-containing monomer containing a carbon-carbon double bond is selected from the group consisting of (trimethylsiloxy)-3-methacryloxypropylsilane, 3-(triethoxysilyl)propyl methacrylate), 3-diethoxymethylsilyl)-propyl methacrylate, vinyltrimethoxysilane, vinyltriethoxysilane, diethoxy(methyl)vinylsilane, 3-methacryloxypropyl-methyldimethoxysilane, 3-methacryloxypropyl-methyldiethoxysilane, 3-methacryloxypropyl-trimethoxysilane, 3-methacryloxypropyl-triethoxysilane, vinyltri(isopropoxy)silane, vinyltripropoxysilane, tris(trimethylsiloxy)silylpropyl methacrylate, bis(trimethylsiloxy)methylsilylpropyl methacrylate, pentamethyldisiloxanepropyl methacrylate, tris(trimethylsiloxy)silyl propyloxyethyl methacrylate, and tris(polydimethylsiloxy)silylpropyl methacrylate, and a mixture thereof.

21. The silicone hydrogel according to claim 11, wherein the hydrophilic monomer having a carbon-carbon double bond is selected from the group consisting of methacrylic acid, acrylic acid, vinyl acetate, ethylene glycol dimethylacrylate (EGDMA), 2-hydroxyethyl methacrylate, 2-hydroxyethyl acrylate, glycerol methacrylate, 2-dimethylaminoethyl acrylate, N-vinyl-N-methyl acetamide, N-vinyl-formamide, N-vinyl pyrrolidone, acryloylmorpholine, methacrylamide, N,N-dimethylacrylamide, N,N-diethylacrylamide, 2-hydroxyethyl methacrylamide, N-isopropylacrylamide, and a mixture thereof.

22. An ocular article made from the silicone hydrogel according to claim 7, wherein the ocular article is a contact lens or an intraocular lens.
